(19) United States
(12) Patent Application Publication
(10) Pub. No.: US 2026/0152148 A1
(43) Pub. Date: Jun. 4, 2026

(54) WIPING DEVICE

(71) Applicant: MITSUBA Corporation, Gunma (JP)

(72) Inventor: TOSHIYUKI AMAGASA, Gunma (JP)

(73) Assignee: MITSUBA Corporation, Gunma (JP)

(21) Appl. No.: 19/122,238

(22) PCT Filed: May 10, 2024
(86) PCT No.: PCT/JP2024/017446

§ 371 Date: Apr. 17, 2025

(30) Foreign Application Priority Data
May 15, 2023 (JP) 2023-080067

(51) Int. Cl. B60S 1/08

(52) U.S. Cl. CPC B60S 1/0822; B60S 1/0896

(57) ABSTRACT

Provided is a wiping device. This wiping device reciprocates a wiper blade by driving a power source by using a prescribed drive signal and corrects the reversing position of the wiper blade by changing the drive signal in accordance with wind pressure applied on the wiper blade. The wiping device includes a drive control unit that acquires a first wind pressure estimation value based on a vehicle speed and a second wind pressure estimation value based on the drive signal, corrects the reversing position on the basis of the first wind pressure estimation value when the first wind pressure estimation value is greater than the second wind pressure estimation value, and corrects the reversing position on the basis of the second wind pressure estimation value when the first wind pressure estimation value is equal to or smaller than the second wind pressure estimation value.

### TECHNICAL FIELD

The disclosure relates to a wiping device.

### RELATED ART

As is well known, various vehicles are equipped with a wiping device that wipes rain water from the surface (surface to be wiped) of a windshield or rear glass. This wiping device wipes rain water from the surface to be wiped by causing a wiper blade to perform a reciprocating motion using a motor (power source). As an example of such a wiping device, Patent Document 1 discloses a window wiping device that uniformly wipes the surface to be wiped by changing a control signal of the motor in response to a wind load obtained from the vehicle speed and/or wiping speed.

### CITATION LIST

### Patent Literature

Patent Document 1: Japanese Patent Application Laid-Open Publication No. 2002-512919

### SUMMARY OF INVENTION

### Technical Problem

However, the technology that changes the control signal of the motor in response to the vehicle speed cannot deal with the effects of crosswinds (headwinds or tailwinds relative to the wiper blade). In other words, with the technology that changes the control signal in response to the vehicle speed, for example, when the wiper blade receives a tailwind, the overrun of the wiper blade may become large, and as a result, there is a risk that the wiper blade may cause interference with another member such as the vehicle's pillar.

The disclosure is made in consideration of the above-mentioned circumstances, and its objective is to provide a wiping device capable of reducing the interference risk between the wiper blade and another member.

### Solution to Problem

To achieve the above objective, as a first solution related to the wiping device, the disclosure adopts a means in which a wiping device causes a wiper blade to perform reciprocating motion by driving a power source with a prescribed drive signal, and corrects a reversing position of the wiper blade by changing the drive signal in response to wind pressure acting on the wiper blade. The wiping device includes a drive control unit that obtains a first wind pressure estimation value based on vehicle speed and a second wind pressure estimation value based on the drive signal, corrects the reversing position based on the first wind pressure estimation value in the case where the first wind pressure estimation value is greater than the second wind pressure estimation value, and corrects the reversing position based on the second wind pressure estimation value in the case where the first wind pressure estimation value is equal to or smaller than the second wind pressure estimation value.

As a second solution related to the wiping device, the disclosure adopts a means in which, in the first solution, the drive signal is a PWM (Pulse Width Modulation) signal, and the drive control unit obtains the second wind pressure estimation value based on a duty ratio of the PWM signal.

As a third solution related to the wiping device, the disclosure adopts a means in which, in the second solution, the duty ratio is an average value over a prescribed period of an outward path or a return path of the wiper blade.

As a fourth solution related to the wiping device, the disclosure adopts a means in which, in any of the first to third solutions, one or two of the power sources are provided, where one of the power source causes one or two of the wiper blades to perform reciprocating motion, and two of the power sources individually cause two of the wiper blades to perform reciprocating motion.

### Effects of Invention

According to the disclosure, it is possible to provide a wiping device capable of reducing the interference risk between the wiper blade and another member.

### BRIEF DESCRIPTION OF DRAWINGS

FIG. 1 is a block diagram illustrating the functional configuration of a wiping device A according to the first embodiment of the disclosure.

FIG. 2 is a flowchart illustrating an operation of the wiping device A according to the first embodiment of the disclosure.

FIG. 3 is a characteristic diagram illustrating a change in correction reference for the reversing position in the first embodiment of the disclosure.

FIG. 4 is a block diagram illustrating the functional configuration of a wiping device B according to the second embodiment of the disclosure.

### DESCRIPTION OF THE EMBODIMENTS

### First Embodiment

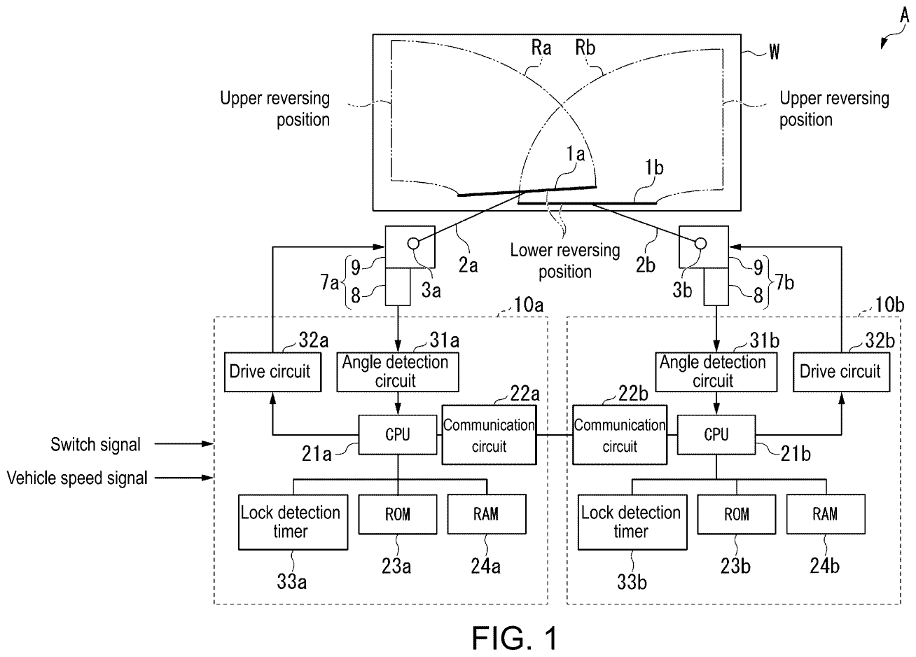

The first embodiment of the disclosure will be described with reference to FIG. 1 to FIG. 3. A wiping device A according to the first embodiment is a device mounted on various types of vehicles such as gasoline vehicles, hybrid vehicles, or electric vehicles, and is a device that wipes off rainwater adhering to the surface (surface to be wiped) of a member to be wiped such as a windshield or rear glass.

This wiping device A adopts a two-motor drive system that individually drives a pair of wiper blades 1a, 1b with a pair of motors 7a, 7b as power sources, as illustrated in FIG. 1. In other words, the wiping device A according to the first embodiment includes two power sources, and uses these two power sources to individually cause the pair of wiper blades 1a, 1b to perform reciprocating motion.

This wiping device A includes, as illustrated, a pair of wiper blades 1a, 1b, a pair of wiper arms 2a, 2b, and a pair of motors 7a, 7b. In the reference numerals in FIG. 1, “a” indicates components or parts that exist or are related to the driver's side of the vehicle. Also, in the reference numerals in FIG. 1, “b” indicates components or parts that exist or are related to the passenger side of the vehicle.

The pair of wiper blades 1a, 1b are rod-like members placed on a windshield W (wiped object), as illustrated. The pair of wiper blades 1a, 1b are in contact with the surface (surface to be wiped) of the windshield W, and wipe off rainwater adhering to the surface to be wiped by performing a reciprocating motion (oscillating motion) on the surface to be wiped. In this FIG. 1, reference symbol Ra indicates the wipe range of the driver side wiper blade 1a, and reference symbol Rb indicates the wipe range of the passenger side wiper blade 1b.

A wipe range Ra on the driver's side extends from the lower reversing position to the upper reversing position of the wiper blade 1a, and is the range of motion of the wiper blade 1a with a driver side wiper axis 3a as a pivot point. In contrast, a wipe range Rb on the passenger side extends from the lower reversing position to the upper reversing position of the wiper blade 1b, and is the range of motion of the wiper blade 1b with the passenger side wiper axis 3b as a pivot point.

The pair of wiper blades 1a, 1b stop for a prescribed period at the lower reversing position and upper reversing position during their reciprocating motion in the wipe ranges Ra, Rb. Specifically, when the pair of wiper blades 1a, 1b move from the lower reversing position towards the upper reversing position, they temporarily stop at the upper reversing position for a prescribed suspension period T, and after this suspension period T has elapsed, they move from the upper reversing position towards the lower reversing position.

The pair of wiper blades 1a, 1b perform reciprocating motion over the wipe ranges Ra, Rb by being driven by the pair of motors 7a, 7b, so the lower reversing position and upper reversing position are set by the pair of motors 7a, 7b. Details will be described later, but the lower reversing position and upper reversing position are corrected in response to the vehicle speed or the drive signals of the pair of motors that drive the pair of wiper blades 1a, 1b, respectively.

The pair of wiper blades 1a, 1b are mechanically connected to the pair of motors 7a, 7b via the pair of wiper arms 2a, 2b. Specifically, the driver side wiper blade 1a is connected to a motor 7a via the wiper arm 2a provided on the driver's side. The passenger side wiper blade 1b is connected to the motor 7b via the wiper arm 2b provided on the passenger side.

The pair of wiper arms 2a, 2b are rod-like members as illustrated, with one end connected to an intermediate part of the pair of wiper blades 1a, 1b, and the other end connected to the pair of wiper axes 3a, 3b. Specifically, the driver side wiper arm 2a has one end connected to an intermediate part of the driver side wiper blade 1a, and the other end connected to the driver side wiper axis 3a.

On the other hand, the passenger side wiper arm 2b has one end connected to an intermediate part of the passenger side wiper blade 1b, and the other end connected to the passenger side wiper axis 3b. Moreover, such pair of wiper arms 2a, 2b are components included in the pair of wiper blades 1a, 1b.

The pair of wiper arms 2a, 2b function as power transmission components that mechanically transmit the pivoting force of the pair of motors 7a, 7b to the pair of wiper blades 1a, 1b. In addition, the pair of wiper arms 2a, 2b function as biasing members that press the pair of wiper blades 1a, 1b against the surface (surface to be wiped) of the windshield W with a prescribed pressing force.

The pair of motors 7a, 7b are power generating devices that cause the pair of wiper blades 1a, 1b to perform reciprocating motion via the pair of wiper arms 2a, 2b. By pivoting the pair of wiper axes 3a, 3b, which are provided on each of the pair of motors 7a, 7b, the pair of wiper blades 1a, 1b placed on the surface (surface to be wiped) of the windshield W are made to perform reciprocating motion within a prescribed angular range.

The pair of motors 7a, 7b serve as power sources corresponding to the pair of wiper axes (output axes) 3a, 3b. The pair of motors 7a, 7b each include a motor body 8 and a deceleration mechanism 9. In addition, the pair of motors 7a, 7b (power sources) include wiper control units 10a, 10b, which are built into each deceleration mechanism 9.

The pair of wiper control units 10a, 10b are drive control units that control the pair of motors 7a, 7b (power sources). The driver side wiper control unit 10a causes the driver side wiper blade 1a to perform reciprocating motion on the surface to be wiped by controlling the driver's side motor 7a. The passenger side wiper control unit 10b causes the passenger side wiper blade 1b to perform reciprocating motion on the surface to be wiped by controlling the passenger side motor 7b.

The driver side wiper control unit 10a includes a CPU (Central Processing Unit) 21a, a communication circuit 22a, a ROM (Read Only Memory) 23a, a RAM (Random Access Memory) 24a, an angle detection circuit 31a, a drive circuit 32a, and a lock detection timer 33a. Similarly, the passenger side wiper control unit 10b includes a CPU 21b, a communication circuit 22b, a ROM 23b, a RAM 24b, an angle detection circuit 31b, a drive circuit 32b, and a lock detection timer 33b.

The driver side wiper control unit 10a and the passenger side wiper control unit 10b are connected for communication via the pair of communication circuits 22a, 22b. In addition, one of the wiper control units 10a is connected to the ECU, which is the vehicle's higher-level control device, via a communication line. In addition to switch signals such as ON/OFF (Lo operation, Hi operation, INT operation) of the wiper switch, ON/OFF of that the mist switch for spraying washer fluid, etc., from the ECU, a vehicle speed signal indicating a vehicle speed V is input to this wiper control unit 10a.

The movement positions of the pair of wiper blades 1a, 1b are set by performing feedback control on the pair of motors 7a, 7b based on the elapsed time of movement from an absolute position that serves as a control reference. In this position control, for example, the lower reversing position is used as the aforementioned absolute position. For the pair of motors 7a, 7b, a target rotation speed TR for the pair of motors 7a, 7b at each point in time is preset as an operation map corresponding to an elapsed time t of movement from the lower reversing position (reference position).

The pair of wiper control units 10a, 10b measure the elapsed time t from the lower reversing position (reference position) in the pair of CPUs 21a, 21b, while also grasping the current rotation speed of the pair of motors 7a, 7b, and compare the current rotation speed at the elapsed time t with the target rotation speed TR on the operation map. The pair of CPUs 21a, 21b generate a pair of PWM (Pulse Width Modulation) drive signals to control the drive of the pair of motors 7a, 7b by performing feedback control on the pair of drive circuits 32a, 32b in response to a difference between the current rotation speed and the target rotation speed TR.

In other words, the upper reversing positions of the pair of wiper blades 1a, 1b are set based on a pair of control command values output from the pair of CPUs 21a, 21b to the pair of drive circuits 32a, 32b, respectively, based on the difference between the current rotation speed and the target rotation speed TR. The pair of drive circuits 32a, 32b set the upper reversing positions to prescribed positions by generating a pair of PWM drive signals to drive the pair of motors 7a, 7b based on the pair of control command values.

In addition, as illustrated in the drawing, a pair of angle detection circuits 31a, 31b for detecting the positions of the pair of wiper blades 1a, 1b are provided between the pair of motors 7a, 7b and the pair of CPUs 21a, 21b. The pair of angle detection circuits 31a, 31b output relative position signals, which are proportional to the rotation angles of the pair of motors 7a, 7b and indicate the amount of movement of the pair of wiper blades 1a, 1b, to the pair of CPUs 21a, 21b.

In other words, the angle detection circuit 31a on the driver's side is provided between the motor 7a on the driver's side and the CPU 21a on the driver's side. This angle detection circuit 31a outputs a relative position signal, which is proportional to the rotation angle of the motor 7a on the driver's side and indicates the amount of movement of the wiper blade 1a on the driver's side, to the CPU 21a. Furthermore, the angle detection circuit 31a outputs an absolute position signal indicating the position of the wiper blade 1a on the driver's side to the CPU 21a.

On the other hand, the angle detection circuit 31b on the passenger side is provided between the motor 7b on the passenger side and the CPU 21b on the passenger side. The angle detection circuit 31b outputs a relative position signal, which is proportional to the rotation angle of the motor 7b on the passenger side and indicates the amount of movement of the wiper blade 1b on the passenger side, to the CPU 21b. Furthermore, this angle detection circuit 31b outputs an absolute position signal indicating the position of the wiper blade on the passenger side to the CPU 21b.

The relative position signals are pulse signals (motor pulses) output from the pair of motors 7a, 7b, respectively, in response to the rotation of the pair of motors 7a, 7b. These relative position signals are pulse signals proportional to the rotation angles of the pair of motors 7a, 7b. The absolute position signals are single pulse signals output from the pair of motors 7a, 7b when the pair of wiper blades 1a, 1b reach the lower reversing position (reference position).

The rotation speeds of the pair of motors 7a, 7b and the rotation speeds of the pair of wiper axes 3a, 3b have a constant relationship based on the reduction ratio of the deceleration mechanism 9. The rotation angles of the pair of wiper axes 3a, 3b are obtained by calculations performed by the pair of CPUs 21a, 21b based on the number of pulses in the relative position signals. Furthermore, the rotation angles of the pair of wiper axes 3a, 3b and the movement angles of the pair of wiper blades 1a, 1b have a constant relationship based on the aforementioned reduction ratio.

In other words, the pair of CPUs 21a, 21b detect the movement angles of the pair of wiper blades 1a, 1b by accumulating the number of pulses in the relative position signals. The pair of CPUs 21a, 21b obtain the current positions of the pair of wiper blades 1a, 1b based on the accumulated result of the number of pulses in the relative position signals and the absolute position signals. In addition, the pair of CPUs 21a, 21b detect the current rotation speeds of the pair of motors 7a, 7b by counting the relative position signals (motor pulses).

Furthermore, the pair of CPUs 21a, 21b measure the elapsed time t from the acquisition time of the absolute position signal using built-in timers. In addition, the pair of CPUs 21a, 21b obtain the target positions of the pair of wiper blades 1a, 1b and the target rotation speeds TR of the pair of motors 7a, 7b for the current elapsed time from the ROMs 23a, 23b.

The pair of CPUs 21a, 21b compare the current positions of the pair of wiper blades 1a, 1b with their target positions, and grasp the current situation of the pair of wiper blades 1a, 1b (the degree of delay or advance relative to the target positions). Moreover, the pair of CPUs 21a, 21b calculate the rotation speeds of the pair of motors 7a, 7b based on the status of the rotation speeds of the pair of motors 7a, 7b (high or low relative to the target rotation speed TR), and control the rotation of the pair of motors 7a, 7b based on these rotation speeds.

In other words, the pair of ROMs 23a, 23b have pre-stored, as an operation map, the target values of the positions of the pair of wiper blades 1a, 1b and the rotation speeds of the pair of motors 7a, 7b, with the elapsed time t from the acquisition time of the absolute position signal as a parameter. The pair of CPUs 21a, 21b perform feedback control on the pair of motors 7a, 7b by comparing the target values and current values of the rotation speeds in such operation maps.

In addition, in each operation map, the lead-follow relationship of the pair of wiper blades 1a, 1b is preset. Furthermore, in each operation map, the target rotation speed TR is determined based on the elapsed time t from the acquisition time of the absolute position signal and the current positions of the pair of wiper blades 1a, 1b, in accordance to the relative positions of one another. For example, even if the elapsed time t and the current positions of the pair of wiper blades 1a, 1b are the same, the target rotation speed TR is set to be higher when the current position of the other wiper blade is close to one's own position, and the target rotation speed TR is set to be lower when the current position of the other wiper blade is farther from one's own position.

Information of the current positions of the pair of wiper blades 1a, 1b are exchanged between the pair of CPUs 21a, 21b via the pair of communication circuits 22a, 22b, and are written into the pair of RAMs 24a, 24b respectively. The pair of CPUs 21a, 21b generate a pair of PWM drive signals to drive the pair of motors 7a, 7b by synchronously controlling the pair of drive circuits 32a, 32b based on the positional relationship of the pair of wiper blades 1a, 1b written in the pair of RAMs 24a, 24b.

Here, the external force acting on the pair of wiper blades 1a, 1b includes wind pressure acting on the pair of wiper blades 1a, 1b. This wind pressure is an external disturbance in the position control of the pair of wiper blades 1a, 1b by the pair of motors 7a, 7b.

This wind pressure is a physical quantity that has a certain correlation with the vehicle speed, and may be estimated (predicted) based on the vehicle speed. Moreover, this wind pressure may be estimated (predicted) based on the drive current of the pair of motors 7a, 7b, which are the power sources for the pair of wiper blades 1a, 1b.

Moreover, the drive current of the pair of motors 7a, 7b is based on the duty ratio of the PWM drive signals supplied to the pair of motors 7a, 7b. Therefore, the aforementioned wind pressure may be estimated (predicted) based on the duty ratio of the PWM drive signals.

Details will be described later, but the pair of CPUs 21a, 21b obtain a wind pressure estimation value E1 (first wind pressure estimation value) based on the vehicle speed and a wind pressure estimation value E2 (second wind pressure estimation value) based on the duty ratio of the PWM drive signals to suppress the variation in the upper reversing position due to the aforementioned wind pressure. In addition, the pair of CPUs 21a, 21b stabilize the variation in the upper reversing position by correcting the target rotation speed TR based on the wind pressure estimation value E1 or the wind pressure estimation value E2.

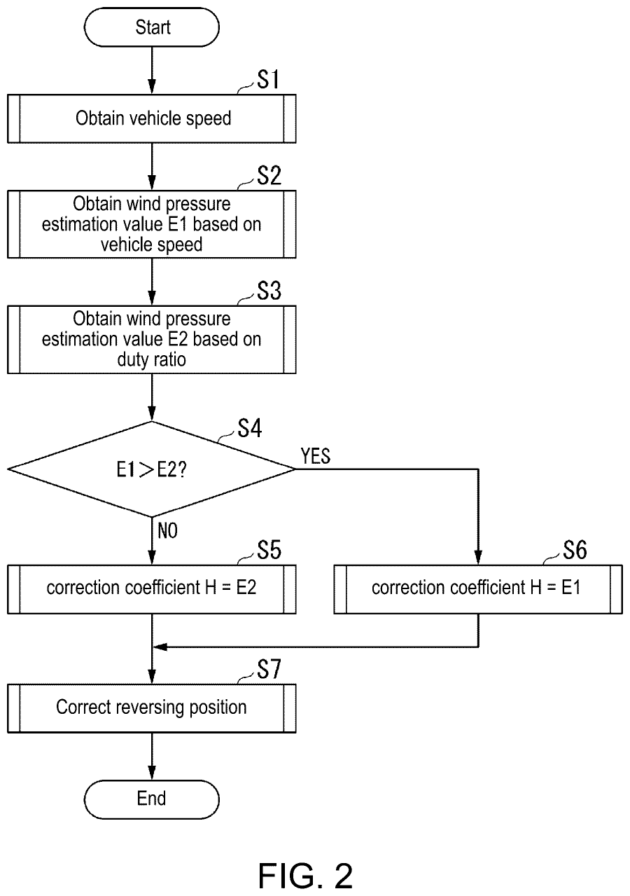

Next, the characteristic operation of the wiping device A according to the first embodiment, that is, the correction processing of the target rotation speed TR based on the vehicle speed and the duty ratio of the PWM drive signals, will be described along with the flowchart illustrated in FIG. 2.

In this wiping device A, the pair of CPUs 21a, 21b obtain the vehicle speed by obtaining switch signals and vehicle speed signals at prescribed timings through communication with a higher-level control device (ECU) (step S1). Then, the pair of CPUs 21a, 21b obtain a wind pressure estimation value E1 as an estimation value of the wind pressure acting on the pair of wiper blades 1a, 1b due to the vehicle speed by applying prescribed calculation processing to the vehicle speed (step S2).

Subsequently, the pair of CPUs 21a, 21b obtain a wind pressure estimation value E2 as an estimation value of the wind pressure acting on the pair of wiper blades 1a, 1b due to the duty ratio by applying prescribed calculation processing to the duty ratio of the PWM drive signals generated by the pair of drive circuits 32a, 32b (step S3).

Here, the duty ratio of the PWM drive signals is set by the control command output by the pair of CPUs 21a, 21b to the pair of drive circuits 32a, 32b. In other words, this control command specifies the duty ratio of the PWM drive signals to the pair of drive circuits 32a, 32b. Therefore, the pair of CPUs 21a, 21b obtain the wind pressure estimation value E2 based on the control command, that is, the duty ratio of the PWM drive signals, which they have obtained.

Furthermore, such wind pressure estimation value E2 is calculated based on, for example, the average value of the duty ratio over a prescribed period of an outward path or a return path of the pair of wiper blades 1a, 1b. In other words, the pair of CPUs 21a, 21b calculate the average value of the duty ratio over a prescribed period by applying averaging processing to multiple chronological duty ratios (control commands) generated at prescribed time intervals, and calculate the wind pressure estimation value E2 using this average value.

When the pair of CPUs 21a, 21b obtain the wind pressure estimation value E1 and the wind pressure estimation value E2, they evaluate the magnitude relationship between the wind pressure estimation value E1 and the wind pressure estimation value E2. In other words, the pair of CPUs 21a, 21b determine in step S4 whether the wind pressure estimation value E1 is greater than the wind pressure estimation value E2.

In the case where the determination in step S4 is “No,” the pair of CPUs 21a, 21b set the wind pressure estimation value E2 as a correction coefficient H (step S5). On the other hand, in the case where the determination in step S4 is “Yes,” the pair of CPUs 21a, 21b set the wind pressure estimation value E1 as the correction coefficient H (step S6). In other words, the pair of CPUs 21a, 21b set the correction coefficient H based on the magnitude relationship between the wind pressure estimation value E1 and the wind pressure estimation value E2.

Then, the pair of CPUs 21a, 21b correct the target rotation speed TR of the operation map obtained from the pair of ROMs 23a, 23b by using the correction coefficient H set through the above processings. In other words, the target rotation speed TR of the pair of wiper blades 1a, 1b is corrected based on the larger wind pressure estimation value among the wind pressure estimation value E1 and the wind pressure estimation value E2 (step S7).

As described above, the wiping device A according to the first embodiment causes the pair of wiper blades 1a, 1b to perform reciprocating motion by driving the pair of motors 7a, 7b (power source) with PWM drive signals (prescribed drive signals), and corrects the upper reversing position of the pair of wiper blades 1a, 1b by changing the PWM drive signals in response to the external force acting on the pair of wiper blades 1a, 1b.

Furthermore, this wiping device A includes a pair of wiper control units 10a, 10b (drive control units), which obtain a wind pressure estimation value E1 (first wind pressure estimation value) based on vehicle speed and a wind pressure estimation value E2 (second wind pressure estimation value) based on the PWM drive signal; correct the upper reversing position of the pair of wiper blades 1a, 1b based on the wind pressure estimation value E1 in the case where the wind pressure estimation value E1 is greater than the wind pressure estimation value E2; and correct the upper reversing position of the pair of wiper blades 1a, 1b based on the wind pressure estimation value E2 in the case where the wind pressure estimation value E1 is equal to or smaller than wind pressure estimation value E2.

In this wiping device A, the larger wind pressure estimation value among the wind pressure estimation value E1 and the wind pressure estimation value E2 is set as the correction coefficient H to correct the upper reversing position of the pair of wiper blades 1a, 1b. Therefore, according to the first embodiment, it is possible to stabilize the variation of the reversing position, and thus provide a wiping device A capable of reducing the interference risk between the pair of wiper blades 1a, 1b and another member (for example, the vehicle's pillar).

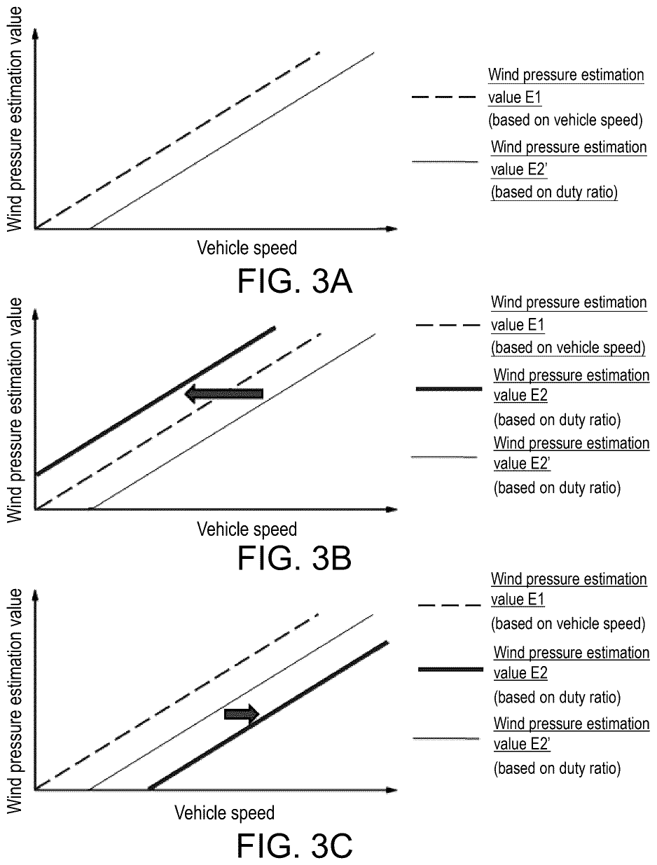

(a) of FIG. 3 illustrates the initial setting of the wind pressure estimation value E1 dependent on vehicle speed and the wind pressure estimation position value E2′. In this (a) of FIG. 3, the dotted line represents the wind pressure estimation value E1 based on the vehicle speed signal, and the solid line represents an initial wind pressure estimation value E2′ based on the duty ratio of the PWM drive signal. As illustrated in this (a) of FIG. 3, the wind pressure estimation value E1 (dotted line) is set to a larger value than the initial wind pressure estimation value E2′ (solid line).

In contrast to the initial setting illustrated in (a) of FIG. 3, (b) of FIG. 3 illustrates the wind pressure estimation value E1 and the wind pressure estimation value E2 in the case where external disturbance due to tailwind acts on the pair of wiper blades 1a, 1b. In this case, the wind pressure estimation value E2 based on the duty ratio becomes larger than the wind pressure estimation value E1 based on the vehicle speed signal because tailwind acts on the pair of wiper blades 1a, 1b. In this case, the wind pressure estimation value E2 based on the duty ratio is set as the correction coefficient H, and the upper reversing position of the pair of wiper blades 1a, 1b is corrected.

On the other hand, in contrast to the initial setting illustrated in (a) of FIG. 3, FIG. 3(c) illustrates the wind pressure estimation value E1 and the wind pressure estimation value E2 in the case where external disturbance due to headwind acts on the pair of wiper blades 1a, 1b. In this case, the wind pressure estimation value E2 based on the duty ratio becomes smaller than the initial wind pressure estimation value E2′ because headwind acts on the pair of wiper blades 1a, 1b. Then, in this case, the wind pressure estimation value E1 based on the vehicle speed signal is set as the correction coefficient H, and the upper reversing positions of the pair of wiper blades 1a, 1b are corrected.

### Second Embodiment

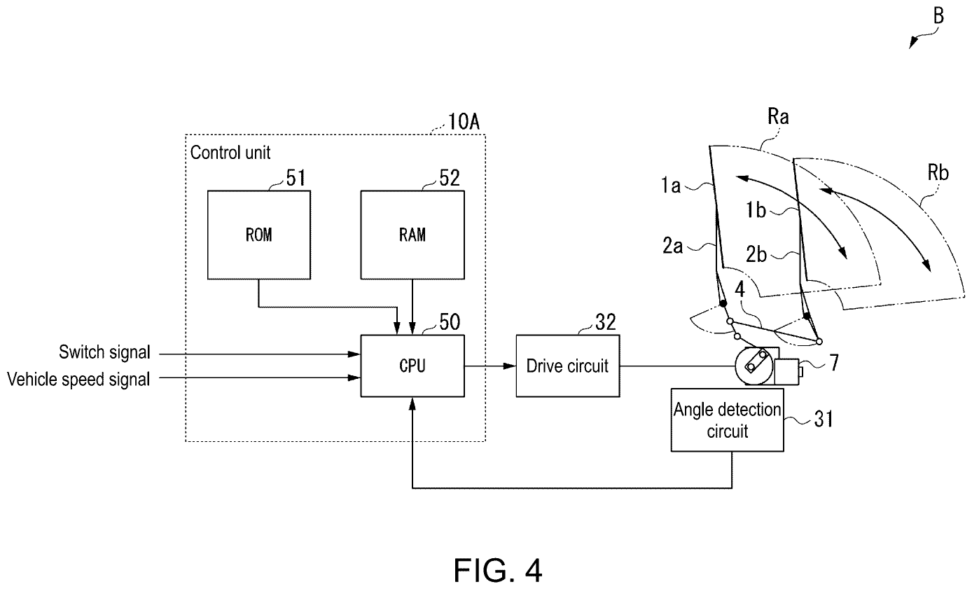

Next, the second embodiment of the disclosure will be described with reference to FIG. 4. Moreover, in this second embodiment, the same reference numerals are assigned to the same components as in the first embodiment.

A wiping device B according to the second embodiment includes, as illustrated in FIG. 4, a pair of wiper blades 1a, 1b, a pair of wiper arms 2a, 2b, a link mechanism 4, a motor 7, an angle detection circuit 31, a drive circuit 32, and a wiper control unit 10A. Moreover, the wiper control unit 10A includes a CPU 50, a ROM 51, and a RAM 52.

This wiping device B adopts a single-motor drive system that drives the pair of wiper blades 1a, 1b with a single motor 7 (power source) by mechanically connecting the pair of wiper arms 2a, 2b with the link mechanism 4. In other words, the wiping device B is provided with one power source, and the pair of wiper blades 1a, 1b perform reciprocating motion using this single power source. This wiping device B, similar to the wiping device A of the first embodiment, wipes rainwater from the surface (surface to be wiped) of the vehicle's windshield or rear glass.

The link mechanism 4 is a mechanical component that is mechanically connected to the other ends of the pair of wiper arms 2a, 2b and is also connected to the output axis of the motor 7. In addition, this link mechanism 4 includes a support axis fixed to the vehicle and is pivotable around this support axis. The motor 7 has its output axis connected to the link mechanism 4, and by manipulating the pivoting angle of the link mechanism 4, it causes the pair of wiper blades 1a, 1b to perform reciprocating motion on the surface to be wiped.

The angle detection circuit 31 has a function similar to the pair of angle detection circuits 31a, 31b in the first embodiment, and outputs a relative position signal that is proportional to the motor rotation angle of the motor 7 and indicates the amount of movement of either the driver side wiper blade 1a or the passenger side wiper blade 1b. Furthermore, this angle detection circuit 31 outputs an absolute position signal indicating the position of a specific wiper blade among the pair of wiper blades 1a, 1b.

The drive circuit 32 has a function similar to the drive circuits 32a, 32b in the first embodiment, and drives the motor 7 based on the control command input from the CPU 50. Specifically, the drive circuit 32 drives the motor 7 according to the difference between the current rotation speed of the motor 7 and the target rotation speed TR.

The wiper control unit 10A has a function similar to the wiper control unit 10a in the first embodiment. In addition, this wiper control unit 10A directly controls the drive circuit 32 by referring to the switch signal and vehicle speed signal input from the higher-level control device, thereby indirectly performing feedback control on the motor 7. In this wiper control unit 10A, the CPU 50 has a function similar to the CPU 21a in the first embodiment. In the second embodiment, the wiper control unit 10A, angle detection circuit 31, and drive circuit 32 may be built into the motor 7.

This CPU 50 controls the drive circuit 32 based on the operation map stored in the ROM 23a, the relative position signal and absolute position signal input from the angle detection circuit 31, and the switch signal and vehicle speed signal input from the higher-level control system. In addition, ROM 51 has a function similar to ROM 23a in the first embodiment and stores the operation map and other data. RAM 52 temporarily holds intermediate data generated by CPU 50.

In this wiping device B, the CPU 50 obtains the vehicle speed by obtaining the switch signal and vehicle speed signal at prescribed timing through communication with the higher-level control device (ECU). Then, the CPU 50 performs prescribed calculation processing on the vehicle speed to determine a wind pressure estimation value E1, which is an estimated value of the wind pressure acting on the pair of wiper blades 1a, 1b due to the vehicle speed.

Then, the CPU 50 performs prescribed calculation processing on the duty ratio of the PWM drive signal generated by the drive circuit 32 to determine a wind pressure estimation value E2, which is an estimated value of the wind pressure acting on the pair of wiper blades 1a, 1b due to the duty ratio.

After obtaining the wind pressure estimation value E1 and the wind pressure estimation value E2 in this manner, the CPU 50 evaluates the magnitude relationship between wind pressure estimation value E1 and wind pressure estimation value E2. Specifically, the CPU 50 determines whether wind pressure estimation value E1 is greater than wind pressure estimation value E2, and in the case where this determination is “No”, it sets wind pressure estimation value E2 as the correction coefficient H.

On the other hand, in the case where the above determination is “Yes”, the CPU 50 sets wind pressure estimation value E1 as the correction coefficient H. In other words, the CPU 50 sets the correction coefficient H based on the magnitude relationship between wind pressure estimation value E1 and wind pressure estimation value E2. Then, the CPU 50 corrects the target rotation speed TR of the operation map obtained from ROM 51 by using the correction coefficient H set by the above processing. Specifically, the target rotation speed TR of the pair of wiper blades 1a, 1b is corrected based on the larger wind pressure estimation value among wind pressure estimation value E1 and wind pressure estimation value E2.

In this manner, the wiping device B according to the second embodiment causes the pair of wiper blades 1a, 1b to perform reciprocating motion by driving the motor 7 (power source) with the PWM drive signal (prescribed drive signal), and corrects the upper reversing position of the pair of wiper blades 1a, 1b by changing the PWM drive signal in response to the external force acting on the pair of wiper blades 1a, 1b.

Furthermore, this wiping device B includes a wiper control unit 10A (drive control unit), which obtains wind pressure estimation value E1 (first wind pressure estimation value) based on the vehicle speed and wind pressure estimation value E2 (second wind pressure estimation value) based on the PWM drive signal; corrects the upper reversing position of the pair of wiper blades 1a, 1b based on wind pressure estimation value E1 in the case where wind pressure estimation value E1 is greater than wind pressure estimation value E2; and corrects the upper reversing position of the pair of wiper blades 1a, 1b based on the wind pressure estimation value E2 in the case where wind pressure estimation value E1 is equal to or smaller than wind pressure estimation value E2.

In this wiping device B, among wind pressure estimation value E1 and wind pressure estimation value E2, the larger wind pressure estimation value is set as the correction coefficient H to correct the upper reversing position of the pair of wiper blades 1a, 1b. Therefore, according to the second embodiment, it is possible to stabilize the variation of the upper reversing position, and thus provide a wiping device B capable of reducing the interference risk between the pair of wiper blades 1a, 1b and another member (for example, the vehicle's pillar).

The disclosure is not limited to the above-described embodiments, and various modifications are possible. For example, the block diagrams in FIG. 1 and FIG. 4 are merely examples of the control configuration, and various modifications are possible within the scope that does not deviate from the spirit of the disclosure.

In addition, in the above-described embodiments, the interference risk with another member (for example, the vehicle's pillar) was reduced by stabilizing the upper reversing position, but the disclosure is not limited to this. For example, in the case where the reference position of the pair of wiper blades 1a, 1b is at the upper reversing position, it is possible to stabilize the variation of the lower reversing position by setting the correction coefficient H based on wind pressure estimation value E1 and wind pressure estimation value E2.

Furthermore, in the above-described embodiments, the drive control unit that drives the power source by adjusting the drive current using the duty ratio of the PWM drive signal was described, but the disclosure is not limited thereto. For example, a drive control unit that generates a drive signal of a type that drives the power source by adjusting the drive current by amplitude may be adopted. Moreover, in this case, the wind pressure estimation value E2 is estimated based on the amplitude of the drive signal.

### Reference Signs List

1a, 1b . . . wiper blade, 2a, 2b . . . wiper arm, 3a, 3b . . . wiper axis, 7a, 7b . . . motor (power source), 10a, 10b, 10A . . . wiper control unit (drive control unit), 21a, 21b, 50 . . . CPU, 22a, 22b . . . communication circuit, 23a, 23b . . . ROM, 24a, 24b . . . RAM, 31a, 31b . . . angle detection circuit, 32a, 32b . . . drive circuit

1. A wiping device that causes a wiper blade to perform reciprocating motion by driving a power source with a prescribed drive signal, and corrects a reversing position of the wiper blade by changing the drive signal in response to wind pressure acting on the wiper blade, the wiping device comprising:
a drive control unit that obtains a first wind pressure estimation value based on vehicle speed and a second wind pressure estimation value based on the drive signal, corrects the reversing position based on the first wind pressure estimation value in the case where the first wind pressure estimation value is greater than the second wind pressure estimation value, and corrects the reversing position based on the second wind pressure estimation value in the case where the first wind pressure estimation value is equal to or smaller than the second wind pressure estimation value.

2. The wiping device according to in claim 1,
wherein the drive signal is a PWM (Pulse Width Modulation) signal, and
the drive control unit obtains the second wind pressure estimation value based on a duty ratio of the PWM signal.

3. The wiping device according to claim 2,
wherein the duty ratio is an average value over a prescribed period of an outward path or a return path of the wiper blade.

4. The wiping device according to claim 1
wherein one or two of the power sources are provided, where one of the power source causes one or two of the wiper blades to perform reciprocating motion, and two of the power sources individually cause two of the wiper blades to perform reciprocating motion.

5. The wiping device according to claim 2,
wherein one or two of the power sources are provided, where one of the power source causes one or two of the wiper blades to perform reciprocating motion, and two of the power sources individually cause two of the wiper blades to perform reciprocating motion.

6. The wiping device according to claim 3,
wherein one or two of the power sources are provided, where one of the power source causes one or two of the wiper blades to perform reciprocating motion, and two of the power sources individually cause two of the wiper blades to perform reciprocating motion.
